(19) United States
(12) Patent Application Publication
(10) Pub. No.: US 2022/0215287 A1
(43) Pub. Date: Jul. 7, 2022

(54) SELF-SUPERVISED PRETRAINING THROUGH TEXT ALIGNMENT

(71) Applicant: SAP SE, Walldorf (DE)

(72) Inventors: Shachar Klaiman, Heidelberg (DE); Marius Lehne, Berlin (DE)

(21) Appl. No.: 17/140,815

(22) Filed: Jan. 4, 2021

(51) Int. Cl. G06N 20/00; G06F 40/126

(52) U.S. Cl. CPC G06N 20/00; G06F 40/126

(57) ABSTRACT

Machine learning models, trained on labeled training data, may be used to categorize documents. To convert data from human-readable text to a form usable by a machine-learning model, a mapping of words to vectors is performed. Learning the mapping to be used is often part of training a machine learning model that operates on text input. A self-supervised pretraining step is performed that aligns the vectors for two or more fields of each document. In this way, when training on the labeled data begins, the vectors used for transforming the text will already be pretrained to give similar values for the two fields. In applications where the two fields are expected to have similar meanings, this pretraining can improve the quality of the resulting model, reduce the amount of training needed, or both.

### TECHNICAL FIELD

The subject matter disclosed herein generally relates to training models using machine learning. Specifically, the present disclosure addresses systems and methods to use unlabeled data to learn a mapping of text to vectors during a pretraining step.

### BACKGROUND

Machine Learning (ML) is an application that provides computer systems the ability to perform tasks, without explicitly being programmed, by making inferences based on patterns found in the analysis of data. ML explores the study and construction of algorithms, also referred to herein as models, that may learn from existing data and make predictions about new data. The dimensions of the input data are referred to as features.

### BRIEF DESCRIPTION OF THE DRAWINGS

Some embodiments are illustrated by way of example and not limitation in the figures of the accompanying drawings.

FIG. 1 is a network diagram illustrating a network environment suitable for self-supervised pretraining through text alignment, according to some example embodiments.

FIG. 2 is a block diagram of a self-supervised pretraining server, according to some example embodiments, suitable for pretraining components of a machine learning model using unlabeled data, according to some example embodiments.

FIG. 3 is a block diagram of a neural network, according to some example embodiments, suitable for use in categorization of documents.

FIG. 4 is a block diagram of a database schema, according to some example embodiments, suitable for use in categorization of documents.

FIG. 5 is a block diagram of a model architecture for self-supervised pretraining through text alignment, according to some example embodiments.

FIG. 6 is a diagram showing relationships between word vectors before and after application of N-pair loss, suitable for use in self-supervised pretraining through text alignment, according to some example embodiments.

FIG. 7 is a block diagram of a model architecture for a classifier that makes use of self-supervised pretraining through text alignment, according to some example embodiments.

FIG. 8 is a block diagram of a model architecture for a classifier that makes use of self-supervised pretraining through text alignment, according to some example embodiments.

FIG. 9 is a flowchart illustrating operations of a method suitable for routing service requests using a machine learning model trained using self-supervised pretraining through text alignment, according to some example embodiments.

FIG. 10 is a block diagram showing one example of a software architecture for a computing device.

FIG. 11 is a block diagram of a machine in the example form of a computer system within which instructions may be executed for causing the machine to perform any one or more of the methodologies discussed herein.

### DETAILED DESCRIPTION

Example methods and systems are directed to self-supervised pretraining through text alignment. Machine learning models are often used to categorize documents. For example, emails may be categorized as business, personal, or advertising. As another example, support tickets submitted to a technical support department may be categorized as connection issues, functionality issues, or business issues. Other examples include categorizing academic papers into fields of study such as science and literature; categorizing court cases by legal topic; and categorizing movie scripts by genre. As used herein, the word document refers to a collection of text, regardless of format. Example documents include word processing files, emails, academic papers, court cases, books, scripts, text submitted through web-based forms, and so on.

Annotated data is used to train models. For example, a document categorization model may be trained on a training set comprising a number of documents, with each document in the training set having a corresponding label. Typically, the labels are added by people. For example, a user interface may be presented that includes a document and provides one or more user interface elements operable to receive the annotation for the document. Thus, the creation of annotated data is labor-intensive and subject to human error.

The model is trained using a training set. Each element of the training set is an input for the machine learning model (e.g., an input document) and a corresponding label. The label for each input is the output that the machine learning model should generate for the input. By processing the training set, the internal variables of the machine learning model are adjusted so that the error rate of the machine learning model is minimized. If the training set is large and representative of data not included in the training set, the trained model will have comparable results on other data.

Applications receive requests from users. For example, customer service systems receive customer service requests from users. A user request includes text, such as a title or subject and a message body. Processing of the request may be based on a category of the request. For example, a customer service request is routed to a customer service agent based on a category of the request. Continuing with this example, a request for help connecting to a system may be routed to a different agent than a request regarding a particular function provided by the system. An application may ask the user directly for the category, but the user-provided category may be incorrect. Additionally, selecting a category is more work for the user. Accordingly, a trained machine learning model may be used to determine a category for received requests based on the text provided by the user.

Training a machine learning model uses a set of labeled training data. For some applications, labeled training data may be readily available. In other applications, generating labeled training data is an expensive and time-consuming process in which a subject-matter expert reviews input data (such as a document to be categorized) and adds a label (the correct category for the document). Pretraining operations that can be performed on unlabeled data that improve the efficiency of training can improve the resulting machine learning model without increasing the size of the labeled training set.

To convert data from human-readable text to a form usable by a machine-learning model, a mapping of words to vectors is performed. However, there is no fixed mapping that is suitable for all applications. Thus, learning the mapping to be used is often part of training a machine learning model that operates on text input.

Many types of documents include multiple fields of text. For example, an academic paper includes a title, an abstract, and a body. As another example, support tickets and emails includes a subject and a body. Books and scripts include titles and bodies. Court cases include a caption, a body, and sometimes a syllabus. As discussed herein, a self-supervised pretraining step is performed that aligns the vectors for two or more fields of each document. For example, a determination of the distance between the average word vector for one field and the average word vector for another field may be performed. Gradient descent or other methods may be used to iteratively adjust the vector mappings to find a minimum of this distance on average over the unlabeled pretraining set. In this way, when training on the labeled data begins, the vectors used for transforming the text will already be pretrained to give similar values for the two fields. In applications where the two fields are expected to have similar meanings, this pretraining can improve the quality of the resulting model, reduce the amount of training needed, or both.

By comparison with existing methods of training models for categorization of documents, the methods and systems discussed herein reduce the level of effort expended in the training process and improve the accuracy of the trained models. Making use of the large quantities of unlabeled data available for many applications allows the improvement of the results without increasing costs and efforts related to document labelling.

When these effects are considered in aggregate, one or more of the methodologies described herein may obviate a need for certain efforts or resources that otherwise would be involved in training machine learning models. Computing resources used by one or more machines, databases, or networks may similarly be reduced. Examples of such computing resources include processor cycles, network traffic, memory usage, data storage capacity, power consumption, and cooling capacity.

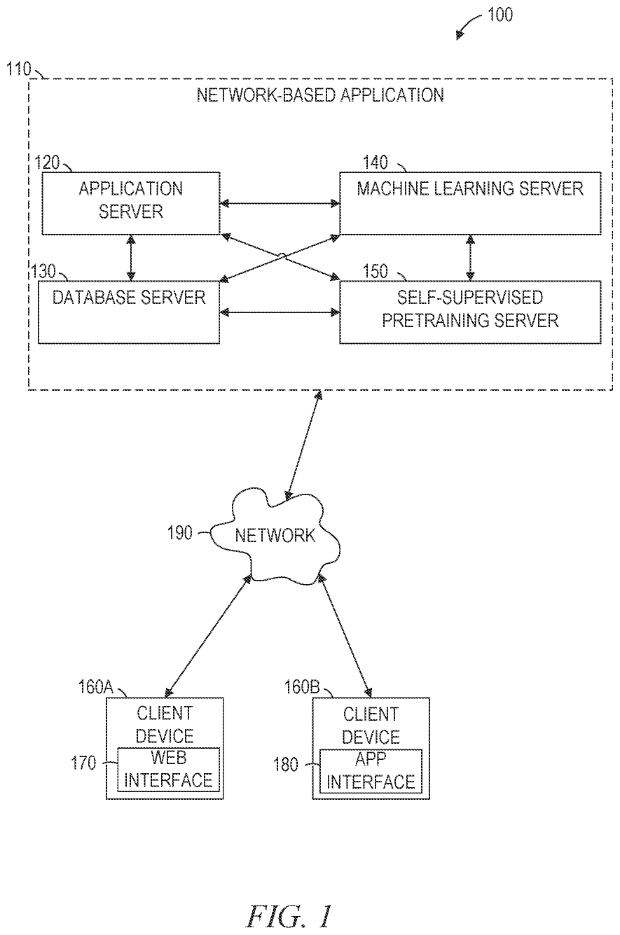

FIG. 1 is a network diagram illustrating a network environment 100 suitable for self-supervised pretraining through text alignment, according to some example embodiments. The network environment 100 includes a network-based application 110, client devices 160A and 160B, and a network 190. The network-based application 110 is provided by application server 120 in communication with a database server 130, a machine learning server 140, and a self-supervised pretraining server 150. The application server 120 accesses application data (e.g., application data stored by the database server 130) to provide one or more applications to the client devices 160A and 160B via a web interface 170 or an application interface 180. For example, the application server 120 may provide a support application that receives help requests from the client devices 160, routes each help request to a service account based on the content of the help request, receives responses from the service accounts, and the response to each help request to the requesting client device 160.

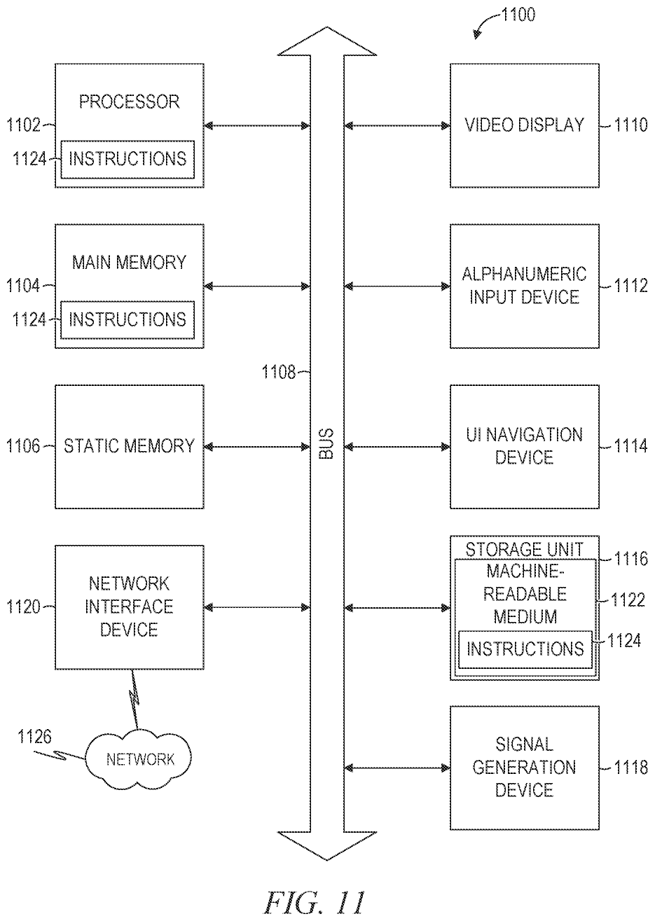

The application server 120, the database server 130, the machine learning server 140, the self-supervised pretraining server 150, and the client devices 160A and 160B may each be implemented in a computer system, in whole or in part, as described below with respect to FIG. 11. The client devices 160A and 160B may be referred to collectively as client devices 160 or generically as a client device 160.

The machine learning server 140 accesses training data from the database server 130. Using the training data, the machine learning server 140 trains a machine learning model that is used by the application server 120. Continuing with the example of a support application, the application server 120 may use the trained machine learning model to classify each help request. Thus, each help request can be automatically routed to the service account based on the classification provided by the machine learning model instead of having a human read the help request and make a judgment as to which service account is correct. In this way, routing is faster and less expensive.

The self-supervised pretraining server 150 accesses unlabeled data from the application server 120, the database server 130, or both. By contrast to the training data, the unlabeled data has not been labeled for training purposes. In this example, labeled help requests include the original help request and the determined classification for the help request; unlabeled help requests include the original help request without its determined classification. Using the unlabeled data, the self-supervised pretraining server 150 trains a component of the machine learning model, prepares an initial state of the machine learning model, or any suitable combination thereof. The machine learning server 140 accesses the pretrained component, initial state, or both from the self-supervised pretraining server 150 prior to beginning training of the machine learning model.

Due to the pretraining performed by the self-supervised pretraining server 150, the machine learning server 140 is able to train a machine learning model using less training data, train a machine learning model to a higher degree of accuracy, or both.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the machine learning server 140, the self-supervised pretraining server, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

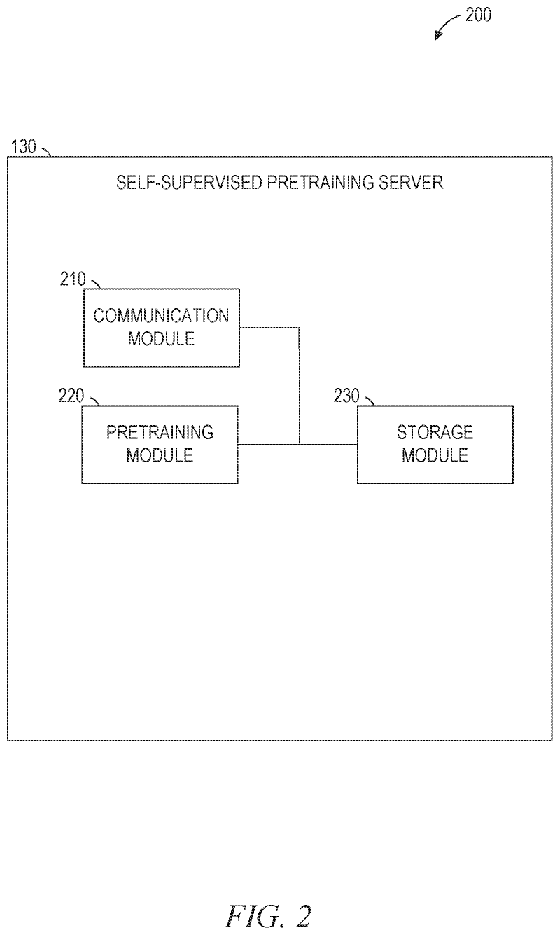

FIG. 2 is a block diagram 200 of the self-supervised pretraining server 150, according to some example embodiments, suitable for pretraining components of a machine learning model using unlabeled data, according to some example embodiments. The self-supervised pretraining server 150 is shown as including a communication module 210, a pretraining module 220, and a storage module 230, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the self-supervised pretraining server 150 and transmits data from the self-supervised pretraining server 150. For example, the communication module 210 may receive, from the application server 120 or the database server 130, unlabeled documents to use for self-supervised pretraining. After the unlabeled documents are used by the pretraining module 220, the results are provided to the machine learning server 140 by the communication module 210. The results may also be stored in the database of the database server 130 via the storage module 250. Communications sent and received by the communication module 210 may be intermediated by the network 190.

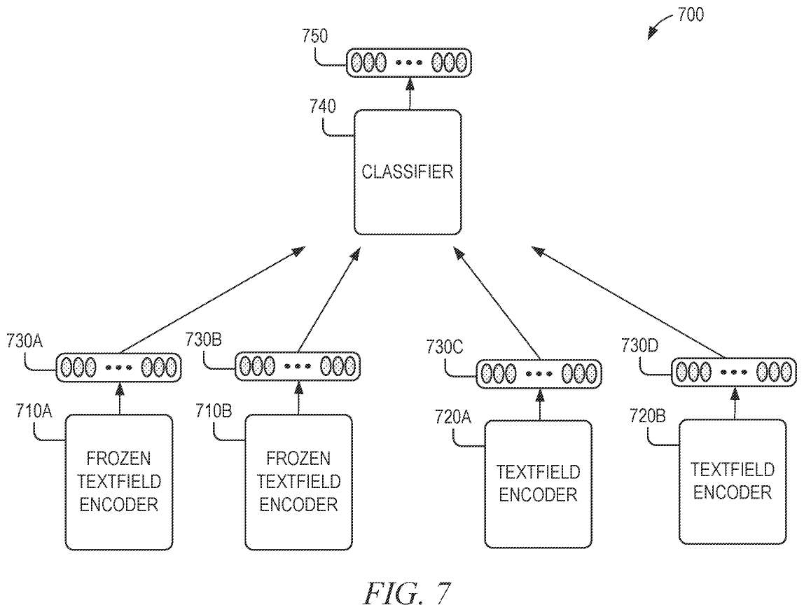

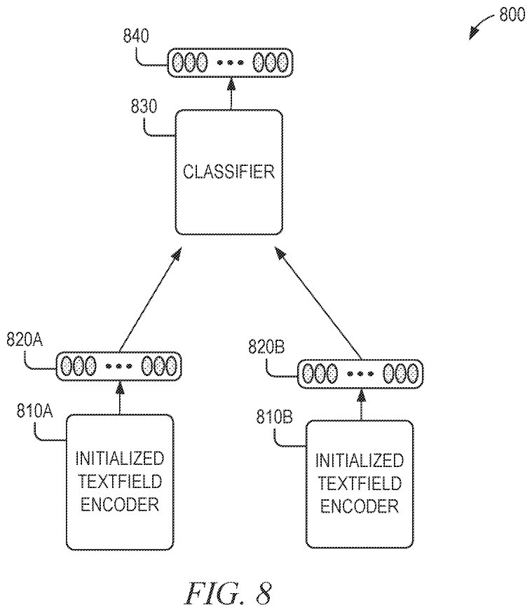

The pretraining module 220 operates on the unlabeled documents to prepare a component or initial state of a machine learning model. For example, as discussed in more detail with respect to FIGS. 7-8 below, the machine learning model may comprise multiple text field encoders, each of which generates a vector for text being classified. One or more of the text field encoders may be pretrained by the pretraining module 220 of the self-supervised pretraining server 150 and zero or more of the text field encoders may be trained by the machine learning server 140.

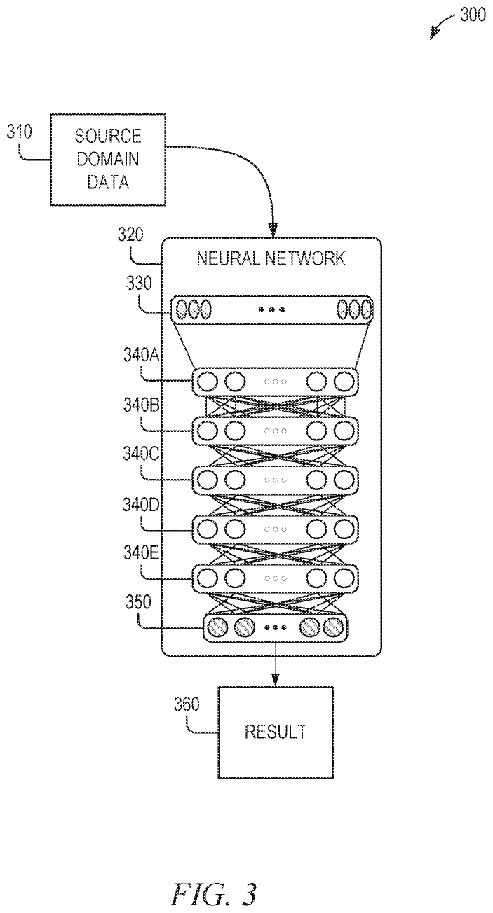

FIG. 3 illustrates the structure of a neural network 320, according to some example embodiments. The neural network 320 takes source domain data 310 as input, processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 340 is the result 360. The intermediate layers 340A-340E are referred to as “hidden” because they do not interact directly with either the input or the output, and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

In a supervised learning phase, a model is developed to predict the output for a given set of inputs, and is evaluated over several epochs to more reliably provide the output that is specified as corresponding to the given input for the greatest number of inputs for the training dataset. The training dataset comprises input examples with labeled outputs. For example, a user may label images based on their content and the labeled images used to train an image identifying model to generate the same labels.

For self-supervised learning, the training dataset comprises self-labeled input examples. For example, a set of color images could be automatically converted to black-and-white images. Each color image may be used as a “label” for the corresponding black-and-white image, and used to train a model that colorizes black-and-white images. This process is self-supervised because no additional information, outside of the original images, is used to generate the training dataset. Similarly, when text is provided by a user, one word in a sentence can be masked and the networked trained to predicted the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). Through the training of a neural network, the inputs of the component neurons are modified. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, deep neural networks, genetic or evolutionary algorithms, and the like.

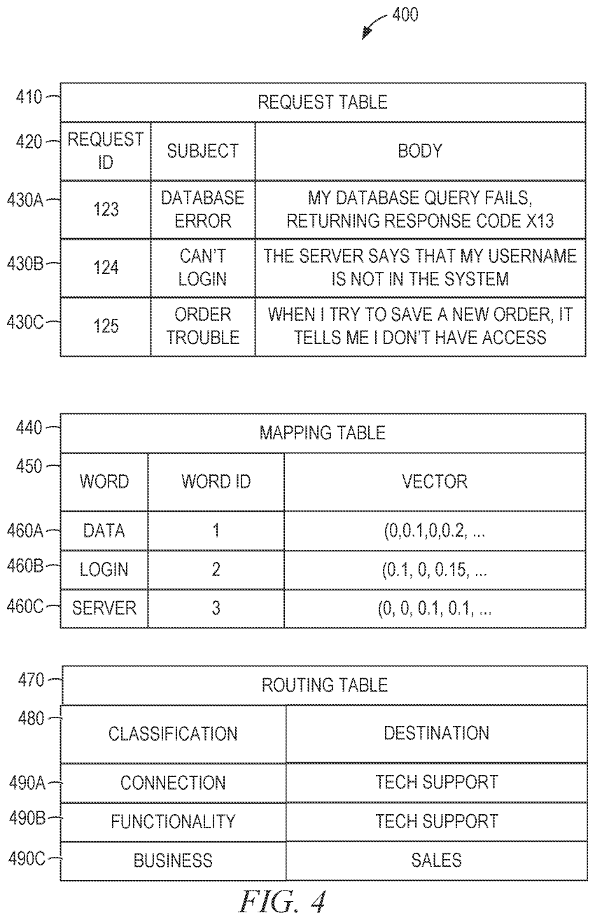

FIG. 4 is a block diagram of a database schema 400, according to some example embodiments, suitable for use in categorization of documents. The database schema 400 includes a request table 410, a mapping table 440, and a routing table 470. The request table 410 includes rows 430A, 430B, and 430C of a format 420. The mapping table 440 includes rows 460A, 460B, and 460C of a format 450. The routing table 470 includes rows 490A, 490B, and 490C of a format 480.

The format 420 of the request table 410 includes a request identifier field, a subject field, and a body field. Each of the rows 430A-430D stores data for a single service request. The request identifier is a unique identifier for the request. For example, when a service request is received, the application server 120 may assign the next unused identifier to the received service request. The subject and the body of the service request are two text fields with different, but related, text. For example, the subject of the request 123 (in the row 430A) is “Database Error” while the body of the request, “My database query fails, returning response code X13” contains more detailed information about the database error.

The format 450 of the mapping table 440 includes a word, a scalar word identifier for the word, and a vector that is mapped to the word. In some example embodiments, the word vector is in a high-dimensional space (e.g., includes one hundred or more dimensions). Accordingly, only a portion of each vector is shown in FIG. 4. The contents of the mapping table 440 may be created by the self-supervised pretraining server 150 using the data in the request table 410.

Each of the rows 490A-490C of the routing table 470 includes a classification field and a destination field, as indicated by the format 480. A service request application provided by the application server 120 can route service requests based on their classifications. For example, service requests related to connection and functionality issues can be routed to tech support while service requests related to business issues can be routed to sales.

In some example embodiments, the word vectors are normalized so that each word vector has a magnitude of one. A vector for text comprising multiple words may be obtained by averaging the vectors of the words in the text. To determine the difference between two vectors, the Euclidean distance formula may be used, taking the square root of the sum of the squares of the differences of corresponding elements of the two vectors.

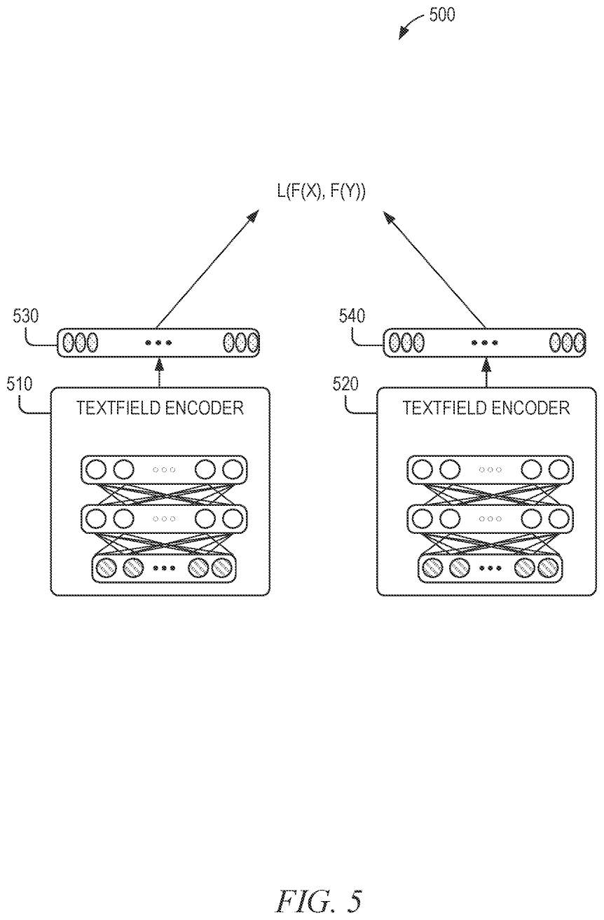

FIG. 5 is a block diagram of a model architecture 500 for self-supervised pretraining through text alignment, according to some example embodiments. The model architecture 500 includes textfield encoders 510 and 520 and resulting vectors 530 and 540. The textfield encoders 510 and 520 are trained so that the distance (or loss) function for two related text fields is reduced or minimized.

The specific architecture of the textfield encoders 510 and 520 may be chosen dependent on the type of input data for an embedding layer that is followed by some encoder architecture that creates a vector from the sequence. Embeddings and encoder parameters are shared between the text fields. In the simplest case the encoder stage is just elementwise average of the token embeddings.

Alternatively, the encoding may include converting pairs of words of the text to bigram vectors and combining the bigram vectors to generate a vector for the text. For example, the text “Database Error” (the subject of the service request of the row 430A) may have a corresponding vector as a bigram, rather than two separate vectors for “Database” and “Error” that are combined. The text “My database query fails, returning response code X13” may be converted to vectors for each of the bigrams “my database,” “database query,” “query fails,” “fails returning,” “returning response,” “response code”, and “code X13.” The vector for a text field may be determined as an average of the bigram vectors for the bigrams in the text field.

For training, a loss function is used that operates without supervised label information, such as a ranking loss function. One type of ranking loss function is the triplet loss function. The triplet loss function takes three samples as input, wherein two of the samples are related and one is not. For example, when working with labeled data, one sample may be an item to be classified, the second sample may be the correct classification (related), and the third sample may be an incorrect classification (unrelated).

Since the data being used by the model architecture 500 is unlabeled, examples other than labels will be used. In some example embodiments, one sample is the vector representing a first text field (e.g., the subject of the request of the row 430A), another sample is the vector representing a second, related, text field (e.g., the body of the request of the row 430A), and the third sample is the vector representing an unrelated text field (e.g., the body of the request of the row 430B). In some example embodiments, the third sample is selected randomly from the available body fields, the available subject fields, or both.

The triplet loss function may be expressed mathematically as:

L(x,x⁺,x⁻)=max(0,∥ƒ−ƒ⁺∥−∥ƒ−ƒ⁻∥+m)

In this equation, x, x⁺, and x⁻ are, respectively, the input value being trained, the positive example, and the negative example; f, f⁺, and f⁻ are the results for the three input values; m is a margin. Thus, the loss for three fields (the x values) is determined by taking the magnitude of the difference between the vectors for the two related fields, subtracting the difference between the vectors for the two unrelated fields, and adding a margin. If that result is negative, the result is the loss. Otherwise, the loss is zero.

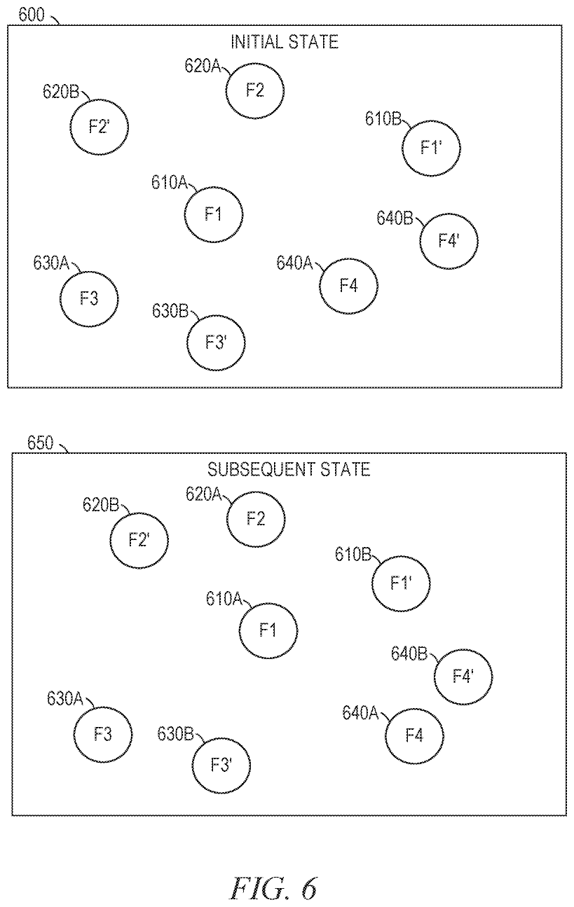

FIG. 6 is a diagram showing relationships between word vectors before and after application of N-pair loss, suitable for use in self-supervised pretraining through text alignment, according to some example embodiments. N-pair loss is an alternative to triplet loss that still uses one related pair of vectors but includes more than one unrelated vector. FIG. 6 shows the initial state 600 and the subsequent state 650. Each state includes the four related pairs of vectors 610A-610B, 620A-620B, 630A-630B, and 640A-640B. The related vectors are also referred to as positive examples while the unrelated vectors are referred to as negative examples. Triplet loss “pulls” using a positive example while “pushing” one negative example at a time. By contrast, N-pair loss pushes N−1 negative examples all at once.

The N-pair loss function may be expressed mathematically as:

$$L ( {\{ {x}_{i} , {x}_{i}^{+} \}}_{i = 1}^{N} ) = \frac{1}{N} {\sum }_{i = 1}^{N} {\sum }_{j \neq i} log ( 1 + exp ( {f}_{i}^{T} {f}_{j}^{+} - {f}_{i}^{T} {f}_{i}^{+} ) )$$

In this equation, xᵢ and xᵢ⁺ are related inputs; fᵢ and fᵢ⁺ are the corresponding related outputs, and fᵢ^{T} is the transpose of fᵢ. Thus, the loss function for the N pairs of related inputs is a function of the similarity of the outputs for the two elements of each pair and the similarity between the output for one element of a pair and an element of each other pair. Applied to the problem of identifying word vectors for service requests, minimizing this loss function will result in word vectors that minimize the difference in vectors that represent related text fields of a single service request while maximizing the difference in vectors that represent text fields from different service requests.

As can be seen in FIG. 6, the result of the N-pair loss function pushes each of the pairs 610A-610B, 620A-620B, 630A-630B, and 640A-640B closer to each other and farther from each other pair.

FIG. 7 is a block diagram of a model architecture 700 for a classifier 740 that makes use of self-supervised pretraining through text alignment, according to some example embodiments. The model architecture 700 includes frozen textfield encoders 710A and 710B, textfield encoders 720A and 720B, result vectors 730A, 730B, 730C, and 730D, the classifier 740, and the output 750. The model architecture 700 receives a document as input to the textfield encoders 710A-720B and generates a classification of the document as the output 750. A “frozen” textfield encoder is a textfield encoder that does not change during training. Thus, the frozen textfield encoders 710A-710B do not change during training of the model architecture 700. The frozen textfield encoders 710A-710B provide the encoding generated during the self-supervised pretraining phase. The textfield encoders 720A-720B may be modified during training, such as by application of gradient descent.

In some example embodiments, each text field of the document is provided as input to one frozen textfield encoder and one (non-frozen) textfield encoder. Fewer than all text fields of the document may be processed in this way. For example, the subject of a service request may be provided as input to the frozen textfield encoder 710A and to the textfield encoder 720A while the body of the service request is provided as input to the frozen textfield encoder 710B and to the textfield encoder 720B. The vectors resulting from the encoding of the texts are provided as input to the classifier 740, which generates the output 750.

By comparison with existing systems that do not include the frozen textfield encoders 710A-710B and initialize the textfield encoders 720A-720B randomly, the model architecture 700 begins the training process with some pretraining already complete. Thus, the initial results of the model architecture 700 benefit from the training of the frozen textfield encoders 710A-710B using unlabeled data comprising two related, but different, text fields.

The textfield encoders 720A-720B may be initialized randomly or as copies of the frozen textfield encoders 710A-710B. In either case, during training, the textfield encoders 720A-720B are modified and thus will not be mere duplicates of the frozen textfield encoders 710A-710B in the resulting model.

FIG. 8 is a block diagram of a model architecture 800 for a classifier 830 that makes use of self-supervised pretraining through text alignment, according to some example embodiments. The model architecture 800 includes frozen initialized textfield encoders 810A and 810B, result vectors 820A and 820B, the classifier 830, and the output 840. The model architecture 800 receives a document as input to the initialized textfield encoders 810A-810B and generates a classification of the document as the output 840. The initialized textfield encoders may be modified during training, such as by application of gradient descent.

In some example embodiments, each text field of the document is provided as input to one initialized textfield encoder. Fewer than all text fields of the document may be processed in this way. For example, the subject of a service request may be provided as input to the initialized textfield encoder 810A while the body of the service request is provided as input to the initialized textfield encoder 810B. The vectors resulting from the encoding of the texts are provided as input to the classifier 830, which generates the output 840.

By comparison with existing systems that do not include the initialized textfield encoders 810A-810B and instead initialize the textfield encoders 810A-810B randomly, the model architecture 800 begins the training process with some pretraining already complete. Thus, the initial results of the model architecture 800 benefit from the training of the initialized textfield encoders 710A-710B using unlabeled data comprising two related, but different, text fields.

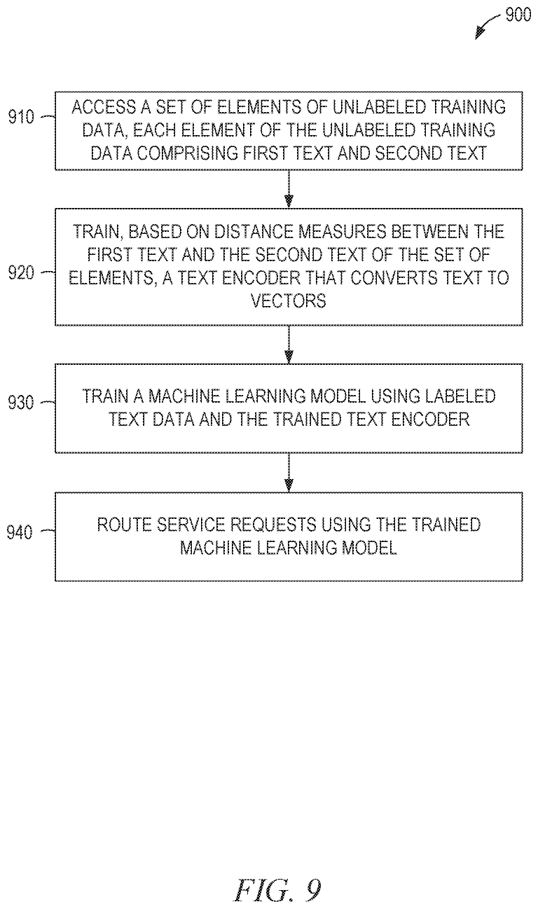

FIG. 9 is a flowchart illustrating operations of a method 900 suitable for routing service requests using a machine learning model trained using self-supervised pretraining through text alignment, according to some example embodiments. The method 900 includes operations 910, 920, 930, and 940. By way of example and not limitation, the method 900 may be performed by the application server 120, the machine learning server 140, and the self-supervised pretraining server 150 of FIG. 1, using the modules, databases, and structures shown in FIGS. 2-7.

In operation 910, the self-supervised pretraining server 150 accesses a set of elements of unlabeled training data, each element of the unlabeled training data comprising first text and second text. For example, the application server 120 may, as an ordinary part of providing an application to the client devices 160, store unlabeled data in a database hosted by the database server 130. The self-supervised pretraining server 150 may periodically access the database to retrieve the unlabeled data. In many applications, the data used by the application server comprises two separate text fields, such as a title and a body of a service request, email, or other document.

The self-supervised pretraining server 150, in operation 920, trains, based on distance measures between the first text and the second text of the set of elements, a text encoder that converts text to vectors. For example, the text may be converted to vectors using an initial mapping (e.g., a random initial mapping) and, using an optimization algorithm (e.g., N-pair loss), a final mapping is learned or determined.

In operation 930, the machine learning server 140 trains a machine learning model using labeled text data and the trained text encoder. In some example embodiments, the machine learning model architecture 700 is used, in which the frozen textfield encoders 710A-710B use the determined mapping and the textfield encoders 720A-720B are trained using labeled text (e.g., classified documents wherein the classification is the label and one or more fields of the document are the text). In other example embodiments, the machine learning model architecture 800 is used, in which the initialized textfield encoders 810A-810B are initialized as copies of the pre-trained text encoder and thereafter trained using labeled text.

The application server 120, in operation 940, routes service requests using the trained machine learning model. The service requests may be received via a user interface and stored in the request table 410. Based on the subject and the body of the service request, the trained machine learning model classifies the service request and routes it to the corresponding destination. For example, with reference to the routing table 470 of FIG. 4, connection and functionality issues may be routed to tech support and business issues may be routed to sales.

Though operation 940 relates to a service request application, other types of applications may use the trained machine learning model instead. For example, the documents may be emails, the two text fields may be the subject and body of the email, and the classifier may determine whether an email is junk mail, personal mail, or work-related mail. Accordingly, in a replacement for operation 940, the application server 120 may process each received email according to its automatic classification. For example, junk mail may be deleted while personal and work-related mail are placed in different folders.

It should be noted that processes may include optional or alternative steps that are not performed in every iteration of the process. Accordingly, multiple execution paths for the process may exist. Over time, the complete state space of the process is observed and mapped using this approach. Thus, the process discovery system described herein is automated and scalable.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, a set of unlabeled training data, each element of the unlabeled training data comprising first text and second text; training, by the one or more processors, based on the set of unlabeled training data, a text encoder that converts text to vectors; training a machine learning model using labeled text data and the trained text encoder; and routing service requests using the trained machine learning model.

In Example 2, the subject matter of Example 1 includes, wherein the first text identifies a subject of a service request.

In Example 3, the subject matter of Examples 1-2 includes, wherein the second text identifies a body of a service request.

In Example 4, the subject matter of Examples 1-3 includes, wherein the training of the text encoder comprises using triplet loss wherein first text of a first element of the unlabeled training data is an input being trained, second text of the first element of the unlabeled training data is a positive example for the input being trained, and first text or second text of a second element of the unlabeled training data is a negative example for the input being trained.

In Example 5, the subject matter of Examples 1-3 includes, wherein the training of the text encoder comprises using N-pairs loss wherein the pairs comprise output generated for the first text and the second text of each element of the unlabeled training data.

In Example 6, the subject matter of Examples 1-5 includes, wherein the training of the machine learning model using the labeled data comprises: initializing the machine learning model with the trained text encoder; and allowing the trained text encoder to be modified during training of the machine learning model.

In Example 7, the subject matter of Examples 1-6 includes, wherein the training of the machine learning model using the labeled data comprises: initializing a first component of the machine learning model with the trained text encoder; and allowing a second component of the machine learning model to be modified during training of the machine learning model without allowing the first component to be modified.

In Example 8, the subject matter of Example 7 includes, wherein: the training of the machine learning model comprises applying gradient descent to the second component.

In Example 9, the subject matter of Examples 7-8 includes, initializing the second component of the machine learning model with random values.

In Example 10, the subject matter of Examples 1-9 includes, wherein the converting of text to vectors comprises: converting individual words of the text to word vectors; and combining the word vectors to generate a vector for the text.

In Example 11, the subject matter of Examples 1-10 includes, wherein the converting of text to vectors comprises: converting pairs of words of the text to bigram vectors; and combining the bigram vectors to generate a vector for the text.

Example 12 is a system comprising: a memory that stores instructions; and one or more processors configured by the instructions to perform operations comprising: accessing a set of unlabeled training data, each element of the unlabeled training data comprising first text and second text; training based on the set of unlabeled training data, a text encoder that converts text to vectors; training a machine learning model using labeled text data and the trained text encoder; and routing service requests using the trained machine learning model.

In Example 13, the subject matter of Example 12 includes, wherein the first text identifies a subject of a service request.

In Example 14, the subject matter of Examples 12-13 includes, wherein the second text identifies a body of a service request.

In Example 15, the subject matter of Examples 12-14 includes, wherein the training of the text encoder comprises using triplet loss wherein first text of a first element of the unlabeled training data is an input being trained, second text of the first element of the unlabeled training data is a positive example for the input being trained, and first text or second text of a second element of the unlabeled training data is a negative example for the input being trained.

In Example 16, the subject matter of Examples 12-15 includes, wherein the training of the text encoder comprises using N-pairs loss wherein the pairs comprise output generated for the first text and the second text of each element of the unlabeled training data.

In Example 17, the subject matter of Examples 12-16 includes, wherein the training of the machine learning model using the labeled data comprises: initializing the machine learning model with the trained text encoder; and allowing the trained text encoder to be modified during training of the machine learning model.

Example 18 is a non-transitory computer-readable medium that stores instructions that, when executed by one or more processors, cause the one or more processors to perform operations comprising: accessing a set of unlabeled training data, each element of the unlabeled training data comprising first text and second text; training based on the set of unlabeled training data, a text encoder that converts text to vectors; training a machine learning model using labeled text data and the trained text encoder; and routing service requests using the trained machine learning model.

In Example 19, the subject matter of Example 18 includes, wherein the first text identifies a subject of a service request.

In Example 20, the subject matter of Example 19 includes, wherein the second text identifies a body of a service request.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

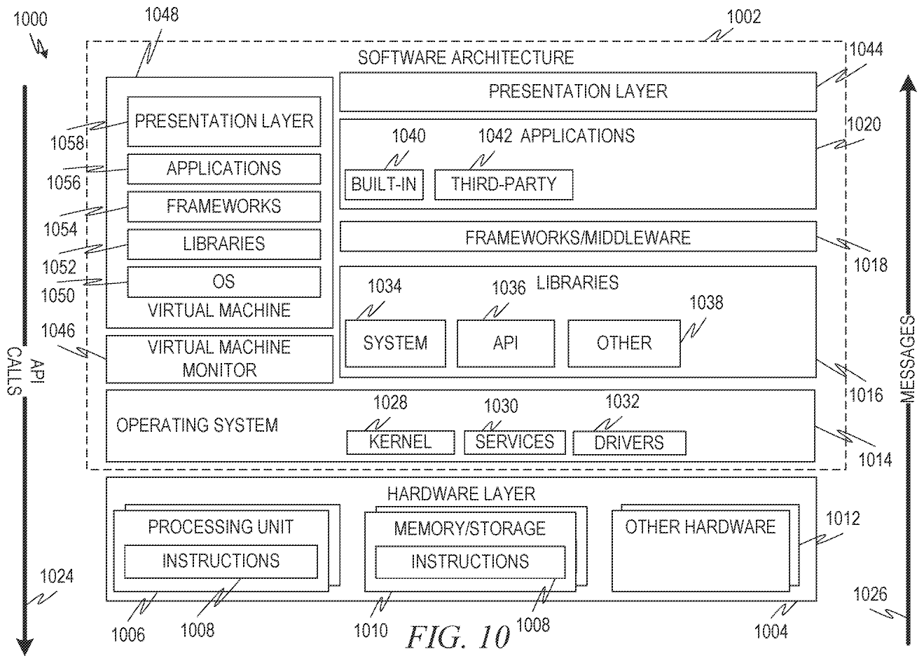

FIG. 10 is a block diagram 1000 showing one example of a software architecture 1002 for a computing device. The architecture 1002 may be used in conjunction with various hardware architectures, for example, as described herein. FIG. 10 is merely a non-limiting example of a software architecture and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke application programming interface (API) calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 and/or drivers 1032), libraries (e.g., system libraries 1034, API libraries 1036, and other libraries 1038), frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of a machine in the example form of a computer system 1100 within which instructions 1124 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### Machine-Readable Medium

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media 1122.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM)disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a set of unlabeled training data, each element of the unlabeled training data comprising first text and second text;
training, by the one or more processors, based on the set of unlabeled training data, a text encoder that converts text to vectors;
training a machine learning model using labeled text data and the trained text encoder; and
routing service requests using the trained machine learning model.

2. The method of claim 1, wherein the first text identifies a subject of a service request.

3. The method of claim 1, wherein the second text identifies a body of a service request.

4. The method of claim 1, wherein the training of the text encoder comprises using triplet loss wherein first text of a first element of the unlabeled training data is an input being trained, second text of the first element of the unlabeled training data is a positive example for the input being trained, and first text or second text of a second element of the unlabeled training data is a negative example for the input being trained.

5. The method of claim 1, wherein the training of the text encoder comprises using N-pairs loss wherein the pairs comprise output generated for the first text and the second text of each element of the unlabeled training data.

6. The method of claim 1, wherein the training of the machine learning model using the labeled data comprises:
initializing the machine learning model with the trained text encoder; and
allowing the trained text encoder to be modified during training of the machine learning model.

7. The method of claim 1, wherein the training of the machine learning model using the labeled data comprises:
initializing a first component of the machine learning model with the trained text encoder; and
allowing a second component of the machine learning model to be modified during training of the machine learning model without allowing the first component to be modified.

8. The method of claim 7, wherein:
the training of the machine learning model comprises applying gradient descent to the second component.

9. The method of claim 7, further comprising:
initializing the second component of the machine learning model with random values.

10. The method of claim 1, wherein the converting of text to vectors comprises:
converting individual words of the text to word vectors; and
combining the word vectors to generate a vector for the text.

11. The method of claim 1, wherein the converting of text to vectors comprises:
converting pairs of words of the text to bigram vectors; and
combining the bigram vectors to generate a vector for the text.

12. A system comprising:
a memory that stores instructions; and
one or more processors configured by the instructions to perform operations comprising:
accessing a set of unlabeled training data, each element of the unlabeled training data comprising first text and second text;
training based on the set of unlabeled training data, a text encoder that converts text to vectors;
training a machine learning model using labeled text data and the trained text encoder; and
routing service requests using the trained machine learning model.

13. The system of claim 12, wherein the first text identifies a subject of a service request.

14. The system of claim 12, wherein the second text identifies a body of a service request.

15. The system of claim 12, wherein the training of the text encoder comprises using triplet loss wherein first text of a first element of the unlabeled training data is an input being trained, second text of the first element of the unlabeled training data is a positive example for the input being trained, and first text or second text of a second element of the unlabeled training data is a negative example for the input being trained.

16. The system of claim 12, wherein the training of the text encoder comprises using N-pairs loss wherein the pairs comprise output generated for the first text and the second text of each element of the unlabeled training data.

17. The system of claim 12, wherein the training of the machine learning model using the labeled data comprises:
initializing the machine learning model with the trained text encoder; and
allowing the trained text encoder to be modified during training of the machine learning model.

18. A non-transitory computer-readable medium that stores instructions that, when executed by one or more processors, cause the one or more processors to perform operations comprising:
accessing a set of unlabeled training data, each element of the unlabeled training data comprising first text and second text;
training based on the set of unlabeled training data, a text encoder that converts text to vectors;
training a machine learning model using labeled text data and the trained text encoder; and
routing service requests using the trained machine learning model.

19. The non-transitory computer-readable medium of claim 18, wherein the first text identifies a subject of a service request.

20. The non-transitory computer-readable medium of claim 19, wherein the second text identifies a body of a service request.
